(19) United States
(12) Patent Application Publication
(10) Pub. No.: US 2011/0055318 A1
(43) Pub. Date: Mar. 3, 2011

(54) Thin client system with round trip reduction using client side code generation

(76) Inventors: Sudharshan Srinivasan, Fremont, CA (US); Kothandraman Ramchandran, Fremont, CA (US); Jai Kumar, Cupertino, CA (US)

(21) Appl. No.: 12/584,383

(22) Filed: Sep. 3, 2009

(51) Int. Cl. G06F 15/16

(52) U.S. Cl. 709/203

(57) ABSTRACT

A method to reduce round trip requests in a thin client system is described. A thin client system is extended with a code generation module (35) that a user can use to generate code fragments (38) or event handlers, that can be executed in the thin client machine so that some user input can be responded to locally at the client itself. This system enables adding event handlers to existing thin client systems without reengineering the associated application software and hence will work with all client server applications. Eliminating some round trip requests can dramatically improve usability of interactive software and reduce bandwidth significantly, hence enabling use of any client server software to be used across high latency, low bandwidth and price sensitive networks.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of Invention

The present invention generally relates to thin client systems and specifically to thin client systems that optimize round trip requests.

2. Prior Art US Patent

Thin client systems are formed using client server software and hardware architecture where the client machine executes client software to interact with a user and the server machine executes server software relating to service logic of an application. From hereon, the term client shall interchangeably refer to both software and hardware at client machine, and the term server shall interchangeably refer to both software and hardware at server machine.

There are several thin client systems in existence today including systems from companies such as Citrix systems, Microsoft, virtual network computing and X.org. All these systems transport graphical user interface contents generated at the server to client software using commonly available networking protocols such as transmission control protocol (TCP) or universal datagram protocol (UDP). These systems also transfer user generated events at the client software into the server software so that a user can interact with service logic of the application in use.

All these systems are usable in low latency networks such as a local area network where round trip latency can be less than twenty milliseconds. But in high latency networks such as internet or wireless cellular packet data network, these systems become unusable for interactive applications. Interactive applications are those that need a response time of less than ten milliseconds. Internet connection speeds and latencies can vary significantly based on the geographical distance between the client and server software. Across continents, the round trip latency can be as high as five hundred milliseconds and inside a continent it may be around fifty milliseconds to hundred milliseconds. Hence software that is engineered for low latency networks cannot be effectively used in high latency networks.

In addition to latency problem, interactive applications generate a number of round trip requests for input events such as mouse move events which lead to excessive bandwidth usage. This can render the system unusable in cellular wireless networks where bandwidth costs are very high.

Hence there is a need for a thin client system that reduces the round trips so that interactive client server applications can be used even in high latency networks or expensive cellular data networks.

Some thin client systems address latency problems by using virtual machines such as Java virtual machine on the client or transporting native code from server to client on demand to run interactive portions of the application on the client.

But such systems can only work with new software that is designed for such use. These systems cannot be used with existing client server software that is designed to be used in low latency networks. In thin client systems using virtual machines, the software logic is partitioned into two parts, one executing in client and the other executing in the server. Such systems are not very successful since partitioning existing software into client and server parts is a non trivial task. It takes a lot of engineering resources to partition existing software based on interactive usage. Even if this partitioning is achieved, for large software programs, the amount of logic that needs to be moved to the client becomes so large that, the thin client solution transforms into a thick client solution mandating large amounts of processing power and memory at the client hardware. This invalidates the advantages of thin client computing that enables client hardware to be made of cheaper components supporting low power computing, while running minimal service logic of application software.

Hence there is a need for a solution that can work with existing software that is engineered for low latency networks but enables use of such software in high latency networks.

Such a solution that addresses the round trip latency problems for existing client server software is not known to exist.

Currently there are no known prior art methods that offer a solution to this problem.

Following paragraphs in current section describe relevant prior arts in this field.

Prior art U.S. Pat. No. 6,538,667 proposes a system to reduce perceived latency problems by a user at the client in a client server system. This is done by predicting a response from the server for each user action at the client and then creating an expected response in the client itself, until a real response is received from the server. This system creates an expected response locally at the client and replaces the created response after a real response is received from the server. This system solves a perceived latency problem by a user with created responses which may not be accurate. Hence some responses may have to be overridden by responses from the server, thus mandating responses from the server for each request.

Thus this system requires all requests be transferred to the server even though a user may be given a perception of a local response, since the local response is not guaranteed to be accurate, a real response has to be waited upon to complete a request response transaction.

So if this requirement is applied to mouse move requests which are usually generated in high numbers, there will be excessive amount round trip requests generated which will render the solution unusable in high latency, low bandwidth, and expensive networks such as cellular wireless data networks.

Also, the prediction module in this system is limited by predetermined patterns limiting the number of events that can be responded to locally. If a user generates a different combination of input events to access similar functionality, the prediction module will fail to recognize the new pattern. Hence this system will work with only a limited number of software programs for which the prediction module is able to predict a potential server response accurately. Hence the main point to note is that in this system, all user generated requests will have to be transported to the server to get an accurate response, thereby mandating a round trip for every request thus not reducing round trips.

As can be seen from above, all known prior arts suffer from some limitations in providing a system that enables use of existing client server software engineered for low latency networks in high latency, low bandwidth and cost sensitive networks.

### OBJECTS AND ADVANTAGES

Accordingly, several objects and advantages of the present invention are:
a) to provide a thin client system that enables client server software engineered for low latency networks to be used in high latency networks without changing existing software;
b) to provide a thin client system that reduces a number of round trips from client to server by not delivering certain requests to server, the requests chosen are such that even when not delivered, do not negatively impact the overall state of server software; and
c) to provide a thin client system that enables building of extensible service logic to handle requests locally at the client based on client usage patterns and user programming abilities.

### SUMMARY

In accordance with present invention a method is provided that enables existing client server software engineered for low latency networks to be made usable in high latency networks by eliminating some specific types of round trip requests.

This is achieved by combining any thin client software with a code fragment generator that enables creation of software code fragments to respond to certain user inputs locally at the client itself to eliminate some round trip requests.

By eliminating some round trip requests, some of the responses to the client are locally generated at the client, and the server is never notified of these requests. These requests are chosen based on behavior analysis of the software program by a user, where not delivering such requests is tolerable to the server state with no adverse affects. For software programs in existence, it is estimated that most interactive functionality that needs server response for each pixel can be reproduced at the client itself without adversely affecting software state at the server.

All software programs have service logic that respond to user inputs. User input to software program can be partitioned into two parts based on the response type from the server. Certain user input produces responses from server based on server internal state, and certain user input produces responses that are independent of server internal state and such responses may be created by just using client state.

User input that produces responses that are dependent on server internal state will be further referred to as server state dependant user input and user input that produces responses that are independent of server internal state will further be referred to as server state independent user input.

Recognizing server state independent user input for which responses are independent of software state at the server is the key to this invention. All server state independent user input are mapped to local software code fragments at the client software thus eliminating round trip requests altogether for certain user inputs.

It can be seen by experience that most software programs have this partition of user inputs and the ratio of server state independent user input to server state dependent user input can be quite high for highly interactive software programs that render graphics for each pixel move of the cursor.

For example a graphics program such as Microsoft paint enables drawing a line from one point to another. This line drawing is made up of the following user inputs, first a mouse down event is generated for the starting point of the line, and then the mouse is dragged to produce events for all intermediate points where intermediate lines are to be drawn, and then finally the mouse is released at the final point to generate a mouse up event where the line needs to end.

Using the system of present invention, all intermediate lines will be drawn using local software code fragments, and only the last line is drawn using a server response. This is because the server program state is not affected by skipping all intermediate mouse move events. Hence it can be seen that if the user moved the cursor over twenty pixels, only one event, that is the last one, generates a round trip request to the server, and all other intermediate mouse moves do not, thereby saving a lot of bandwidth and eliminating latency problems for all but one event.

This system of mapping certain user input to local software code fragments is achieved by providing an environment at the client to enable any user to create software code fragments that mimic server responses. By enabling creation of software code fragments, a user can create software code fragments for all server state independent user input.

Hence combining a thin client with code fragment generator, and installing the generated software code fragments as response handlers in the thin client enables cutting of round trip requests significantly. Ability for a user to generate software code fragments provides a customized and extensible framework where new logic can be installed when necessary instead of scanning for fixed set of patterns. This enables exact responses to be created at client duplicating server behavior without round trip requests and without reengineering existing application service logic at server.

New software code fragments may be automatically generated by mapping user input and server responses or may be aided by the user by manually recording his inputs and editing software code fragments that may be generated automatically.

This system should not be viewed as a simple record replay system where user behavior is recorded and replayed identically. But in this system, user behavior is recorded to generate software code fragments that enable local response generation at the client. Hence this system should be viewed as local response system using dynamic code generation.

This system is also not similar to the one where a client is implemented with software code fragments such as Java applets from the server, since such a system is not flexible or extensible based on user behavior patterns. Remotely downloaded software code fragments are usually software code fragments that are controlled by the developer of the software program, and the developer usually chooses the superset approach by packaging all code that can possibly be used by any user into downloadable software code fragments, thus increasing the size of the download and increasing the size of the client as a whole. Also, such code fragments do not work with existing software and mandate reengineering existing software to fit this model.

Enabling a user to setup new software code fragments based on his/her usage pattern is the key to achieving a small footprint extension to a thin client while serving all users in most of their usage scenarios where there is a need for round trip reduction, and works with all existing software without the need for reengineering.

The code generated at the client may be done automatically or with user intervention. Hence combining a code generation system with thin client software produces the unobvious result of reducing round trip requests between client and server software, without significantly increasing the size of thin client, thereby enabling software engineered for low latency networks to be usable in high latency, low bandwidth and cost sensitive networks.

Enabling code generation locally at the client enables use of existing client server software without reengineering in high latency networks unlike other systems that mandate a complete redesign. This system also saves on bandwidth usage that can be significant if round trip requests associated with mouse move events can be eliminated altogether, thus enabling use of any client server software in high latency, low bandwidth, and cost sensitive cellular packet data networks.

### DRAWINGS

### Figures

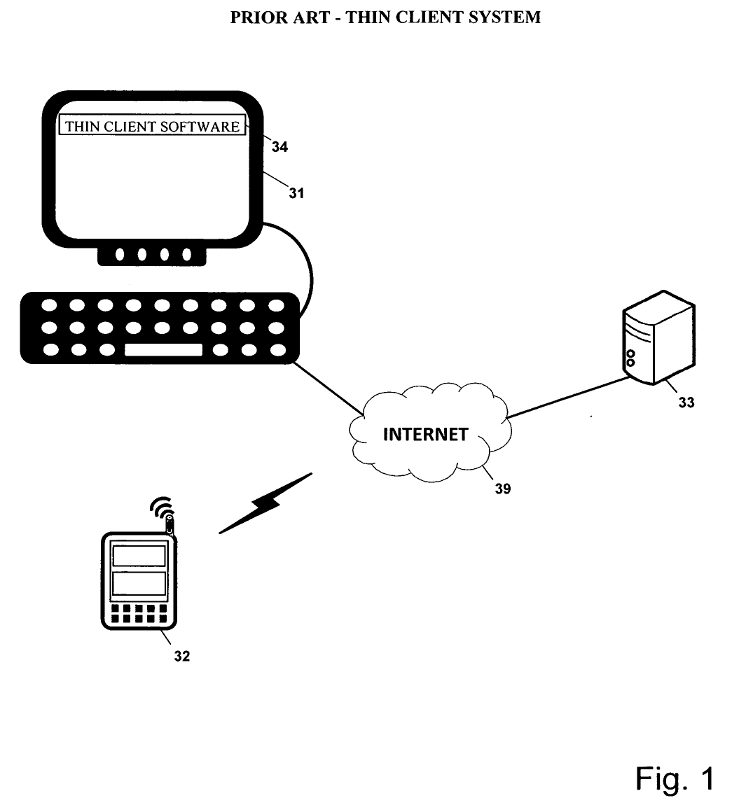

FIG. 1 shows prior art system of thin client and server.

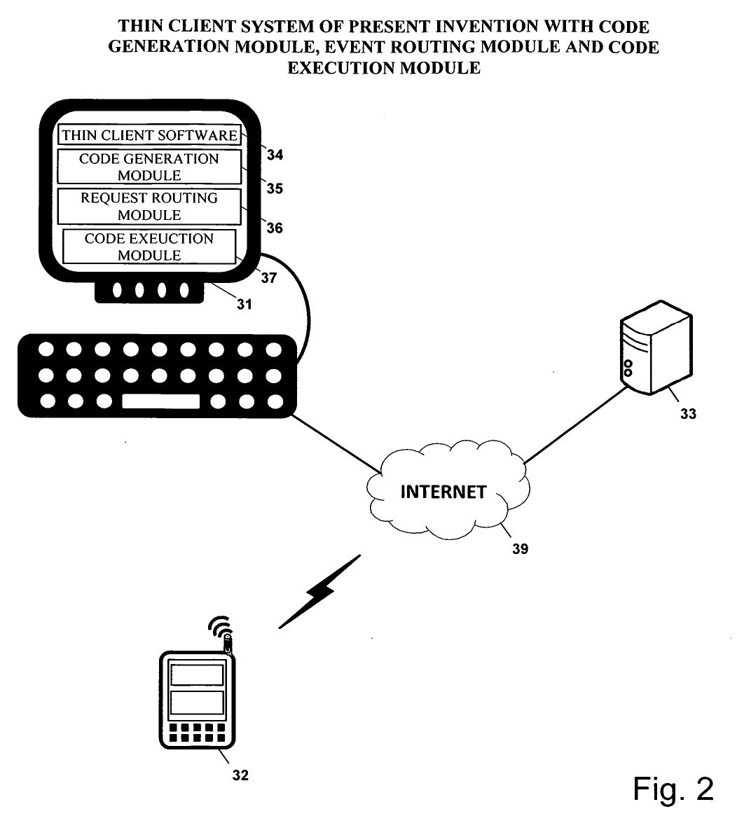

FIG. 2 shows thin client system of present invention with additional components at thin client including code generation module, request routing module, and code execution module.

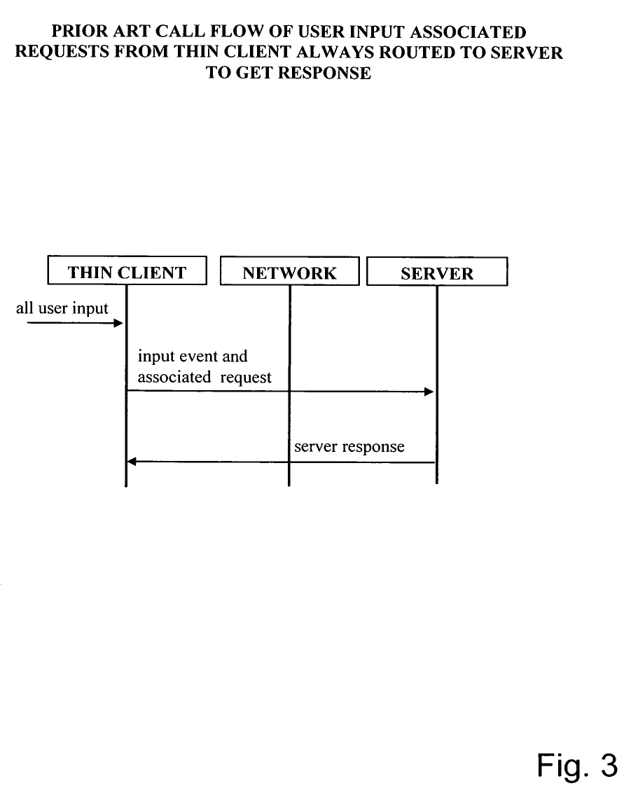

FIG. 3 shows call flow of prior art thin client system.

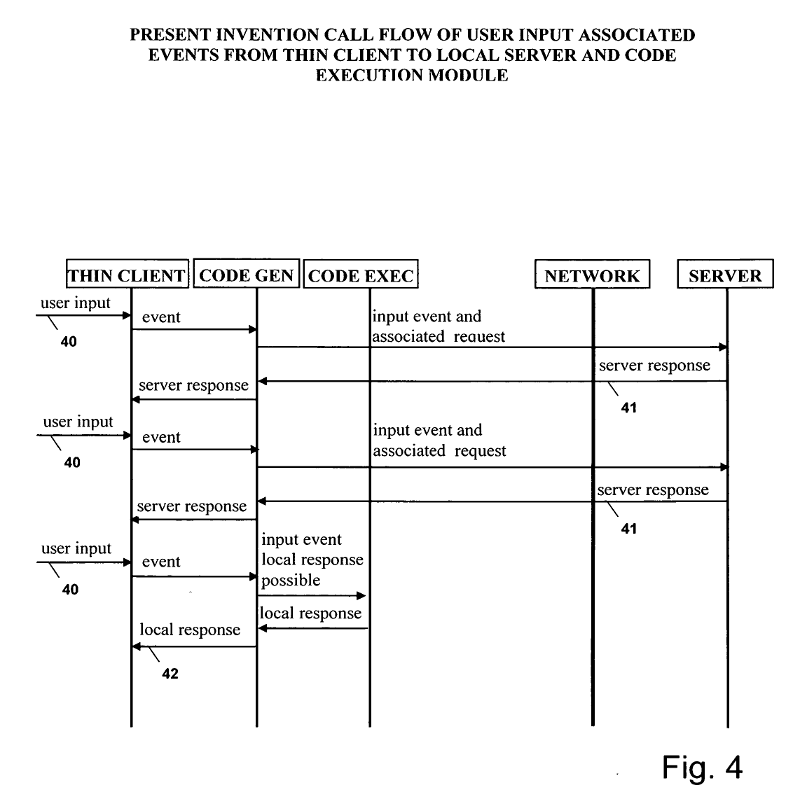

FIG. 4 shows call flow of thin client system of present invention.

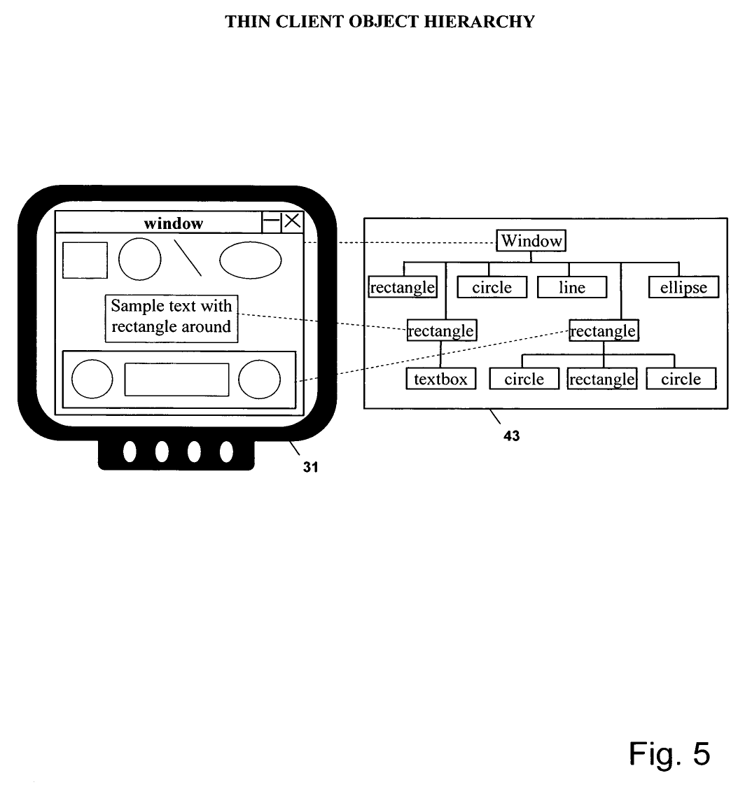

FIG. 5 shows object hierarchy of drawing objects in thin client of present invention.

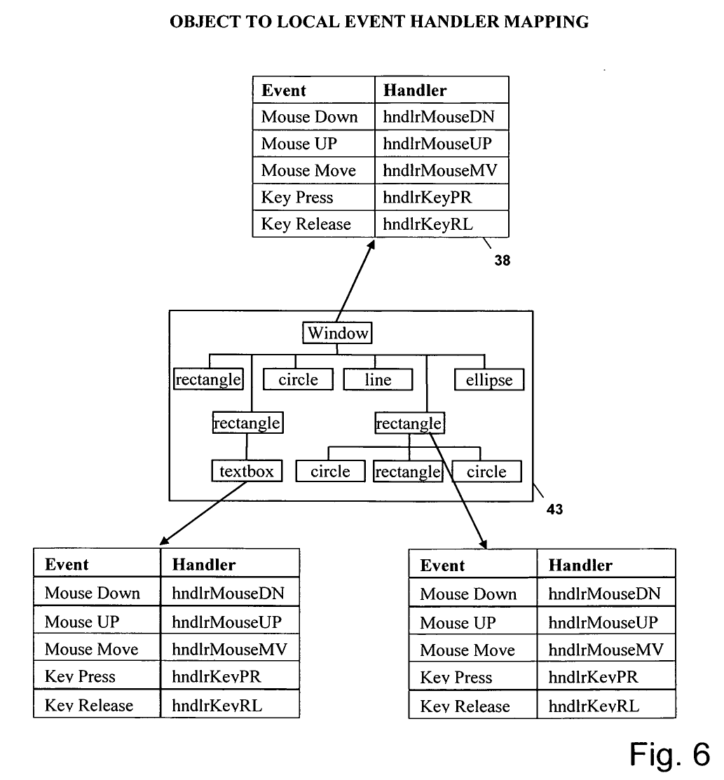

FIG. 6 shows object mapping to even handlers in thin client of present invention.

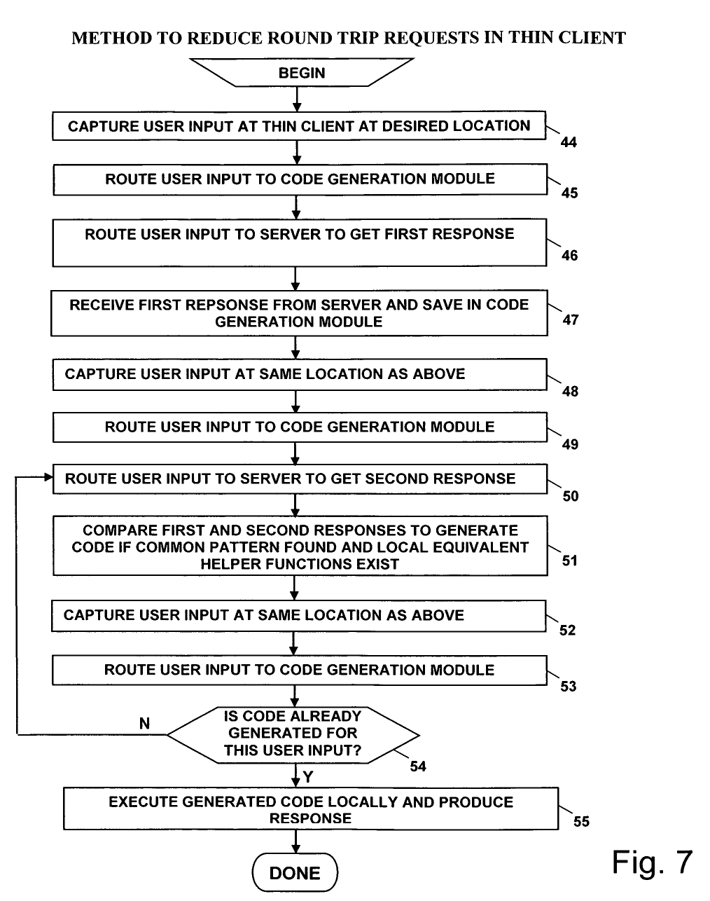

FIG. 7 shows flow chart for method to reduce round trip requests in thin client of present invention.

### DRAWINGS

### Reference Numerals

31 desktop based thin client machine
32 mobile device based thin client
33 application server
34 thin client software
35 code generation module
36 request routing module
37 code execution module
38 code fragments
39 internet
40 user input
41 server response
42 local response
43 graphics object tree
44 step
45 step
46 step
47 step
48 step
49 step
50 step
51 step
52 step
53 step
54 step
55 step

### DETAILED DESCRIPTION OF PREFERRED EMBODIMENT

In the following description, thin client system of present invention is described. First a comparison between prior art thin client system and thin client system of present invention is described and then details of the method and modules of thin client system of present invention are described.

FIG. 1 shows a prior art thin client system where the thin client is capable of only rendering graphics output of software applications executing at the server. Here thin client machine is shown as a desktop based thin client machine 31 and a mobile device based thin client 32 machine. It can be seen that in this system each user input request has to be transferred to application server 33 and hence encountering latency and bandwidth issues.

FIG. 2 shows a thin client system of present invention. Here thin client machine is shown as desktop based thin client machine 31 and a mobile device based thin client 32 machine. Each of these machines, execute thin client software 34. This thin client software 34 is enhanced with additional functionality including code generation module 35, request routing module 36, and code execution module 37. Code generation module 35 enables creation of code fragments 38 that are executed by code execution module 37. Request routing module 36 enables routing of user input based requests to local request handlers instead of sending such requests to application server 33. Connectivity between thin client machines and application server 33 could be through internet 39 or other high latency, low bandwidth and price sensitive networks.

FIG. 3 shows a call flow for prior art thin client system where a user input based request is sent a response from application server 33. It can be seen here that each of the user inputs are transferred to the server 33, as the thin client in this system does not have the ability to respond locally. Hence each request has to be transferred from thin client into server, thus rendering this solution unusable for interactive applications that may need response for all user inputs including mouse moves.

FIG. 4 shows a call flow for thin client system of present invention. This figure shows how the same user input request is routed through the code generation module 35 for first two times, and third time onwards this request is responded to locally at the thin client by code execution module 37 without passing such a request to the application server 33. First time user input 40 is routed to code generation module 35, which saves it for future comparison and then routes it to application server 33. Application server 33 sends back a server response 41 which is received at code generation module 35 and saved as first response for future comparison.

When user input 40 is again received at the related location at graphics output of thin client software 34, the same process is repeated and the second response from application server is compared with first response to determine if there is a common pattern of graphics primitives that can be seen across two user input requests and corresponding responses.

If a common pattern is seen, then this common pattern is converted into code fragments 38 that can be executed by code execution module 37 and this code fragment is associated with user input 40, so that any future user input at the same or related location as before can be responded to with generated code fragment 38 as a local response 42.

If there is no commonality found, a user has a choice of writing scriptable code as the code fragment in a higher level language and associate with any graphics output of thin client software 34. This particular feature that enables any user to add code fragments to thin client software is unique to present invention. None of the existing systems in prior art provide this feature. Prior art systems either mandate code fragments to be transferred from a server, or no code fragments are allowed, and either of these schemes is limiting as described background section in this document.

FIG. 5 shows how all the graphics output in thin client software 34 is saved for future use as a graphics object tree 43. Saving an object tree enables thin client software 34 to map user input to objects that may be made up of several graphics primitives. For example, a textbox may be made up of a rectangle and text inside of it, and both these combined can be viewed as a single object. This graphics primitive to object mapping enables user input at related locations in graphics output to be mapped to locally generated code fragments 38. The local graphics object tree 43 also enables functions such as scrolling or overlaying one object on another to implement layer support where objects can be arranged in a stack have a Z ordering among them. Z order determines which object is in the forefront and has keyboard and mouse event focus.

FIG. 6 shows how each of the objects in graphics output of thin client software 34, are mapped to local code fragments also called event handlers. It can be seen that any graphics object can be mapped to local code fragments to process user input locally. User input can be any input such as keyboard related events, mouse related events, and events from other input devices.

FIG. 7 shows details of the method to reduce round trip requests. In step 44 user input 40 is captured at a desired location at graphics output of thin client software 34. The desired location can be a specific pixel or it can be a set of related pixels representing a set of graphics output representing a graphics object.

In step 45 user input 40 is routed to code generation module 35. Code generation module 35 stores user input and associated location for future comparison with similar user input at related location.

In step 46 user input 40 is then routed to application server 33, to get a server response 41.

In step 47 server response is received 41 by code generation module 35 is received and saved as first server response for future comparison.

In step 48 user input 40 is again received at a related location as in step 44.

In step 49 user input 40 is again routed to code generation module 35.

In step 50 application server 33 sends back a response to second user input to code generation module 35 which saves it as a second response.

In step 51, the first and second responses are compared to see if any commonality exists. If commonality is found, then local code fragment 38 is generated to mimic the functionality of the server. Then this code fragment is installed as a local handler to respond to user input 40 from within the client instead of routing to server.

In step 52, user input 40 is captured again for the third time, at the related location as the first two captures as in steps 44 and 48.

In step 53, user input captured for third time, is once again routed to code generation module 35.

In step 54, a check is made to see if there is already code generated for user input 40 and its associated location, and if this is found to be true, then the generated code fragment 38 is executed in step 55. If there is no code fragment found for the user input and location combination, then this event is stored at code generation module 35 and the user input is routed to application server 33 as in step 50 and the process is repeated for future events.

### ADVANTAGES

From the description above a number of advantages of this interactive radio system become evident:
a) a thin client system is provided that enables client server software engineered for low latency networks to be used in high latency networks without changing existing software;
b) a thin client system is provided that reduces a number of round trips from client to server by not delivering certain requests to server, the requests chosen are such that even when not delivered, do not negatively impact the overall state of server software; and
c) a thin client system is provided that enables building of extensible service logic to handle requests locally at the client based on client usage patterns and user programming abilities.

### CONCLUSION, RAMIFICATIONS AND SCOPE

Accordingly, the reader will see that combining a thin client with a code generation and execution module provides an unobvious result of reducing round trip requests without significantly increasing the code size of thin client and without any change to application service logic.

Although the description above contains many specificities, these should not be construed as limiting the scope of invention but merely as providing illustrations of some of the presently preferred embodiments of this invention. Thus the scope of this invention should be determined by appended claims and their legal equivalents, rather than by example given.

We claim:

1. A method to reduce round trip requests in thin client software wherein said thin client software at a client machine displays graphical data output of service logic of an application running at a server machine, and transfers input from a user interacting with said graphical output at said client machine to said application running at said server machine to get responses for said user input, comprising:
a) associating additional software code fragments with some parts of said graphical output at said thin client to locally handle some of said user input at said thin client instead of routing all such said user input to said server.

2. The method to reduce round trip requests in thin client software of claim 1, further comprising:
a) determining if response to said user input at said graphical output can be generated locally; and
b) executing said associated software code fragments to generate a response locally at said thin client if said determination is positive and not route said user input to said server.

3. The method to reduce round trip requests in thin client software of claim 1, wherein said thin client is selected from group consisting of Citrix thin client, Microsoft thin client, X Windows thin client, virtual networking client thin client, and other thin clients which display graphical output of applications running at said server.

4. The method to reduce round trip requests in thin client software of claim 1, wherein said thin client machine is selected from group consisting of laptop computer, desktop computer, netbook computer, smartphone, and programmable device capable of rendering graphics output from said application at said server.

5. A method to reduce round trip requests in thin client software wherein said thin client software at a client machine displays graphical data output of service logic of an application running at a server machine, and transfers input from a user interacting with said graphical output at said client machine to said application running at said server machine to get responses for said user input, comprising:
a) capturing said user input as user input of first time at a desired location in display of said thin client, and routing said user input of first time to a code generation module at said thin client and saving said desired location and said user input of first time for future comparison at said code generation module;
b) routing said user input of first time from said code generation module to said server software;
c) receiving first response from said server software into said code generation module;
d) storing said response as first response in said code generation module for future comparison;
e) capturing said user input second time as user input of second time, at said desired location and routing said user input of second time, to said code generation module at said thin client and saving said desired location and said user input of second time for future comparison;
f) routing said user input of second time, at said code generation module to said server software;
g) receiving second response from said server software for said user input of second time, into said code generation module;
h) comparing said first response and said second response to generate code if a repeat pattern is found between said first response and said second response; and
i) saving said generated code as local input handler to said user input at said desired location if said generated code is an acceptable replacement for said first and second responses.

6. The method to reduce round trip requests in thin client software of claim 5, further comprising:
a) receiving said graphical output from said server and creating a local representation of all said graphical output as a content tree of drawing objects for hierarchical grouping of drawing objects at said thin client; and
b) using said tree of graphical objects to determine routing of said user input to said local input handlers.

7. The method to reduce round trip requests in thin client software of claim 6, further comprising:
partitioning said graphics output in said content tree into several groups of related nodes in said hierarchy wherein each said group represents a graphics object representing a functional view of said service logic.

8. The method to reduce round trip requests in thin client software of claim 7, further comprising:
mapping said graphics objects to said user input at said thin client; and
mapping said user input received by said graphics objects to said generated code.

9. The method to reduce round trip requests in thin client software of claim 5, further comprising:
partitioning said user input into two types, first type where response for this type of user input from said server is dependent on server internal state, second type where response for this type of user input from said server is independent of server internal state and an alternate response can be locally generated based on client state alone.

10. The method to reduce round trip requests in thin client software of claim 9, further comprising:
mapping said second type of user input to said generated code to reduce said round trip requests.

11. The method to reduce round trip requests in thin client software of claim 5, further comprising:
controlling the size of said generated code to keep the overall size of said thin client from growing beyond the capabilities of said thin client machine.

12. The method to reduce round trip requests in thin client software of claim 5, wherein said code generation method is selected from group consisting of automatic code generation method, and manual code generation method, wherein said automatic code generation method detects repeated patterns of responses for input from said user to generate said code and map said user input to said generated code automatically, and said manual code generation method enables mapping of responses for user input to said generated code manually by said user.

13. The method to reduce round trip requests in thin client software of claim 5, wherein said thin client is selected from group consisting of Citrix thin client, Microsoft thin client, X Windows thin client, virtual networking client thin client, and other thin clients which display graphical output of applications running at said server.

14. The method to reduce round trip requests in thin client software of claim 5, wherein said thin client machine is selected from group consisting of laptop computer, desktop computer, netbook computer, smartphone, and programmable device capable of rendering graphics output from said application at said server.

15. A system to reduce round trip requests in thin client software wherein said thin client software at a client machine displays graphical data output of service logic of an application running at a server machine, and transfers input from a user interacting with said graphical output at said client machine to said application running at said server machine to get responses for said user input, comprising:
a) thin client software;
b) code generation module to generate code to replace said server responses for selected requests from said user;
c) code execution module to execute said generated code; and
d) request routing module to route events that are generated by user input to said code execution module before routing said event to said server.

16. The method to reduce round trip requests in thin client software of claim 15, further comprising:
a editor module enabling editing of generated code using said code generation module; and
a debugging module enabling debugging of said generated.
